(19) United States
(12) Patent Application Publication
(10) Pub. No.: US 2024/0111109 A1
(43) Pub. Date: Apr. 4, 2024

(54) CONNECTOR FOR ALIGNMENT OF INTEGRATED WAVEGUIDES AND OPTICAL FIBERS

(71) Applicant: CORNING RESEARCH & DEVELOPMENT CORPORATION, CORNING, NY (US)

(72) Inventors: Lars Martin Otfried Brusberg, Corning, NY (US); Jason Roy Grenier, Horseheads, NY (US); Jürgen Matthies, Ruhr (DE)

(21) Appl. No.: 18/381,438

(22) Filed: Oct. 18, 2023

Related U.S. Application Data
(63) Continuation of application No. PCT/US22/24513, filed on Apr. 13, 2022.
(60) Provisional application No. 63/177,468, filed on Apr. 21, 2021.

(51) Int. Cl. G02B 6/42

(52) U.S. Cl. CPC G02B 6/4292; G02B 6/4231; G02B 6/4257

(57) ABSTRACT

Systems and methods are provided for connection of an optical fiber to a substrate. The substrate may comprise waveguide(s), guide pin(s), and a substrate body. The guide pin(s) define a first and second end and comprise a capture feature proximate the second end. The substrate body comprises a receiving feature configured to receive and connect the first end of guide pin(s), and the second end of guide pin(s) extends outwardly from the substrate body. The system also comprises a connector configured to receive the optical fiber and including a receiver portion that has a locking feature and defines a recess configured to receive the guide pin(s). The capture feature is configured to engage with the locking feature. When the capture feature is engaged with the locking feature, the optical fiber is aligned with the optical waveguide(s) and restrained from movement relative to the substrate.

### PRIORITY APPLICATION

This application is a continuation of International Patent Application No. PCT/US2022/024513 filed on Apr. 13, 2022, which claims the benefit of priority of U.S. Provisional Application No. 63/177,468, filed on Apr. 21, 2021, the content of each aforementioned application is relied upon and incorporated herein by reference in its entirety.

### FIELD OF THE INVENTION

Embodiments of the present invention relate to connection systems and methods for effectively aligning an integrated waveguide and one or more optical fibers.

### BACKGROUND OF THE INVENTION

Optical fibers are used for routing optical signals over long distances (e.g., wide area networks (WAN), metropolitan area networks (MAN), local area networks (LAN), racks, etc.). By contrast, optical interconnects (e.g., waveguides) are integrated in substrate materials like glass, polymer, silicon or others for short reach interconnects with lengths of up to −1 m.

For the optical interface between the optical fiber and integrated waveguides, a connector solution that is standardized, low cost, and high performance is desirable. Some specific types of connectors (e.g., Multi-fiber Termination Push-on (MTP) connectors and Multi-fiber Push-on (MPO) connectors) have been developed that are state-of the art solutions for multi-fiber connectors in datacenters and other applications. Integrated optical waveguides in glass (e.g., Ion-exchange (IOX), laser-direct writing, deposition) or polymer are promising technologies for fabrication of low-loss optical substrates, such as for interposers, packaging substrates, and circuit board optical interconnects. Integrated optical waveguides in silicon, silicon nitrate, and deposited doped fused silica are promising technologies for fabrication of highly integrated photonic circuits, such as for transceivers, multiplexer, splitters, sensors, etc. To enable and deploy the waveguide technology in datacenters, high-performance computers, and other applications, a standard interface is desirable between the optical fiber(s) and integrated waveguides.

An approach for effectively aligning waveguides and optical fibers in a cost-effective manner is therefore desired.

### SUMMARY OF THE INVENTION

Alignment between the integrated waveguides and optical fiber(s) can be difficult. Further, maintaining a small form factor to enable attachment and management of many different optical fibers is desirable. In this regard, various features may be employed to aid in alignment, however, such features each require alignment and have their own dimensions and geometries that have to be accounted for. This often means that connection using several different components results in intolerances “stacking” on top of each other, leading to additional inaccuracies in alignment.

Some current interfaces require active alignment in order to account for such difficulties in obtaining proper alignment. Where active alignment is used, a powered system is required to align the system that transmits optical test signals and seeks to optimize the optical test signals. Active alignment, however, is costly and time-consuming.

Systems, components, and methods described herein enable easy and proper alignment of a substrate and waveguides therein/thereon with one or more optical fibers. This may be accomplished through passive alignment, which permits cost-efficient assembly of components. The substrate may, for example, be any type of substrate, such as an electro-optical substrate, optical substrate (optical waveguides but no electrical lines), photonic integrated circuit (PIC) like silicon photonics, planar lightwave circuit (PLC) like optical splitters, fan-out or break out modules, three-dimensional photonic integrated circuits having one or more waveguides buried below the surface, etc.

Various embodiments of the present invention provide one or more components for connecting and aligning one or more optical fibers to one or more optical waveguides on a substrate, a PIC, or a planar lightwave circuit (PLC) (e.g., planar glass waveguides, such as IOX, deposited, laser written waveguides comprising polymer, silicon, silicon nitrate, and/or silica material). The connector may abut and/or envelop a substrate edge of the substrate. The substrate body of the substrate may be processed (e.g., through laser processing, milling, dicing, etching, or lithography) to make an optical facet and/or provide mechanical alignment features for very precise alignment in reference to the waveguides. In some embodiments, all components of the system (e.g., guide pin(s) and the connector) may be passively aligned directly to the substrate body by automated machines, enabling high-volume processing which leads to higher yield and cost savings.

In some embodiments, various features may be processed into a top surface of a substrate body of the substrate, which may lead to large scale panel level processing (cost savings) and quality improvements through inspection (e.g., through top view microscopy) to find non-good parts (out of specifications). Further, in some embodiments, guide pins may be used and may be directly attached to the substrate body, and this may reduce the stack of tolerances and lead to lower coupling loss and better performance.

Guide pins are provided with capture features, and these capture features may be configured to engage with a locking feature in a connector to cause alignment of an optical fiber with one or more waveguides. The capture feature may also restrain the movement of the optical fiber relative to a substrate. By using guide pins having this capture feature, a plastic receptacle does not need to be used with the substrate. The connector height and width may therefore be reduced, leading to a smaller form-factor and a higher edge-density. Without any plastic receptacle, the substrate thickness may also be minimized. Further, without plastic parts, the substrate is also high-temperature stable for solder reflow or thermo-compression bonding and is compatible with low cost electronic packaging/assembly. A dust protection may be temporarily attached for protecting the cleanness of the substrate during electronic packaging/assembly and handling/shipping.

In an example embodiment, a system is provided for aligning a substrate with an optical fiber. The system may comprise an optical fiber and a substrate. The substrate may comprise one or more optical waveguides, at least one guide pin, and a substrate body. The at least one guide pin comprises a capture feature proximate the second end. The substrate body comprises a receiving feature configured to receive and also removably or permanently connect to the first end of the at least one guide pin, and the second end for the at least one guide pin extends outwardly from the substrate body. The system also comprises a connector, and the connector comprises at least one receiver portion. The at least one receiver portion defines a recess and has a locking feature, and the connector is configured to receive the optical fiber. The recess of the at least one receiver portion is configured to receive the at least one guide pin. The capture feature is configured to engage with the locking feature. When the capture feature is engaged with the locking feature, the optical fiber is aligned with the one or more optical waveguides and restrained from movement relative to the substrate.

In some embodiments, the capture feature of the at least one guide pin comprises a first portion proximate to the second end and a second portion proximate to the second end. The first portion may have an increased thickness relative to the second portion, and the first portion may be closer to the second end than the second portion. At least one of the first portion or the second portion is configured to engage with the locking feature.

In some embodiments, the capture feature is a groove within the at least one guide pin. The at least one guide pin may be removably or permanently connected to the receiving feature using adhesive in some embodiments.

In some embodiments, the connector may also comprise a finger tab with the finger tab that enables a user to grip the connector and provide a retraction force to cause the locking feature to release from a capture state and enable relative movement of the at least one guide pin with respect to the locking feature. The connector may further comprise a spring. When the locking feature releases from the capture state, the spring may be configured to push the locking feature away from the at least one guide pin.

In some embodiments, the system comprises a ferrule and a spring. The ferrule is positioned between the substrate and the spring. The ferrule is configured to receive/hold the optical fiber and the at least one guide pin. When the at least one guide pin is shifted towards the locking feature, the spring generates a force against the ferrule to urge the ferrule towards the substrate. In some embodiments, the spring may be configured to urge an end-face of the optical fiber received within the ferrule against an optical waveguide in the substrate. In some embodiments, the system comprises an anti-reflection coating or an index matching material. The ferrule is configured to receive the optical fiber, and the optical fiber comprises an end-face. The spring is configured to urge the ferrule proximate to the substrate while leaving a gap between the end-face of the optical fiber and the one or more optical waveguides of the substrate. The anti-reflection coating or the index matching material is deposited in the gap and against the end-face. In some instances, the additional force generated by the spring is between 0.5 N and 2 N and the anti-reflection coating or the index matching material contacts the optical fiber and the one or more optical waveguides of the substrate.

In some embodiments, the receiving feature is a trench, and the trench comprises two side edges and a bottom surface. The trench is configured so that the at least one guide pin rests against the two side edges without contacting the bottom surface. The trench may be formed using a laser based approach.

The one or more optical waveguides provided within the substrate are subsurface or buried optical waveguides in some embodiments. However, surface optical waveguides may be used as well. Optical waveguides may be also in different layers or planes. In some embodiments, an attachment is provided, and the receiving feature may be provided on the attachment. The substrate may be configured to receive and also removably or permanently connect to the attachment.

In another example embodiment, a connector is provided for aligning a substrate having one or more optical waveguides with an optical fiber. The connector comprises at least one receiver portion. The at least one receiver portion defines a recess and comprises a locking feature. The connector is configured to receive the optical fiber, and the recess of the at least one receiver portion is configured to receive at least one guide pin associated with the substrate. When received, the locking feature is configured to retain the at least one guide pin in the recess. When the at least one guide pin is retained by the locking feature, the optical fiber is aligned with the one or more optical waveguides of the substrate and restrained from movement relative to the substrate.

In some embodiments, the connector further comprises a finger tab. The finger tab is configured to enable a user to grip the connector and provide a retraction force to cause the locking feature to release from a capture state and enable relative movement of the at least one guide pin with respect to the locking feature. The connector may further comprise a spring. When the locking feature releases from the capture state, the spring is configured to push the locking feature away from the at least one guide pin.

In some embodiments, the connector further comprises a ferrule and a spring. The ferrule is positioned between the substrate and the spring, and the ferrule is configured to receive the optical fiber and the at least one guide pin. When the at least one guide pin is shifted towards the locking feature, the spring generates a force against the ferrule to urge the ferrule towards the substrate. Thus, the end-face of the optical fiber within the ferrule may make contact with the substrate.

In yet another example embodiment, a substrate for providing electrical and optical connections to at least one photonic integrated circuit is provided. The substrate comprises one or more optical waveguides, at least one guide pin, and a substrate body. The at least one guide pin defines a first end and a second end, and the at least one guide pin comprises a capture feature proximate the second end. The substrate body comprises a receiving feature configured to receive and also removably or permanently connect to the first end of the at least one guide pin. The second end for the at least one guide pin extends outwardly from the substrate body. The capture feature is configured to engage with a connector. When the capture feature is engaged with the connector, an optical fiber associated with the connector is aligned with the one or more optical waveguides of the substrate and restrained from movement relative to the substrate.

In some embodiments, the capture feature of the guide pin comprises a first portion proximate to the second end of the guide pin and a second portion proximate to the second end of the guide pin. The first portion has an increased thickness relative to the second portion, and the first portion is more proximate to the second end than the second portion. At least one of the first portion or the second portion is configured to engage with the locking feature.

Further areas of applicability of the present invention will become apparent from the detailed description provided hereinafter. It should be understood that the detailed description and specific examples, while indicating example preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1A is a perspective view of an example substrate showing a substrate body having a receiving feature, in accordance with some embodiments discussed herein;

FIG. 1B is a perspective view of the substrate of FIG. 1A with a guide pin received in each receiving feature, in accordance with some embodiments discussed herein;

FIG. 1C is a perspective view of the substrate of FIG. 1B with guide pins received within a connector, in accordance with some embodiments discussed herein;

FIG. 2A is a side view of a substrate having two receiving features where guide pins are received in each of the receiving features, in accordance with some embodiments discussed herein;

FIG. 2B is a top view of the substrate of FIG. 2A, in accordance with some embodiments discussed herein;

FIG. 3A is a perspective view of a ferrule of a multi-fiber optical connector useable with the alignment pins and the substrate of FIGS. 2A and 2B, in accordance with some embodiments discussed herein;

FIGS. 3B and 3C are end elevational views of a ferrule with different numbers of optical fiber bores and different alignment hole spacing, in accordance with some embodiments discussed herein;

FIG. 3D is an end elevational view of a ferrule portion of a multi-fiber optical connector and a substrate, in accordance with some embodiments discussed herein;

FIG. 4A is a bottom schematic view of a cover that may be used in conjunction with the receiving features of the substrate to removably or permanently connect to one or more guide pins, in accordance with some embodiments discussed herein;

FIG. 4B is a perspective view of the cover illustrated in FIG. 4A, in accordance with some embodiments discussed herein;

FIG. 4C is a front view of the cover illustrated in FIG. 4A, in accordance with some embodiments discussed herein;

FIG. 4D is a side view of the cover illustrated in FIG. 4A, in accordance with some embodiments discussed herein;

FIG. 5A is a side view of an example substrate end-face, in accordance with some embodiments discussed herein;

FIG. 5B is a close-up side view of a portion of an example substrate end-face, in accordance with some embodiments discussed herein;

FIG. 5C is a close-up side view of a portion of another example substrate end-face, in accordance with some embodiments discussed herein;

FIG. 6A is a perspective view of a system for aligning a substrate with one or more optical fibers where guide pins have not yet been received in the connector or ferrule, in accordance with some embodiments discussed herein;

FIG. 6B is a cross sectional view of the system illustrated in FIG. 6A, in accordance with some embodiments discussed herein;

FIG. 6C is a close-up view of a portion of the system illustrated in FIG. 6B, where the guide pin and a hole within a ferrule may be seen, in accordance with some embodiments discussed herein;

FIG. 7A is a perspective view of a system for aligning a substrate with an optical fiber where guide pins have been partially received in a connector and a ferrule, in accordance with some embodiments discussed herein;

FIG. 7B is a cross sectional view of the system illustrated in FIG. 7A, in accordance with some embodiments discussed herein;

FIG. 8A is a perspective view of a system for aligning a substrate with an optical fiber where guide pins have been received within a connector and a ferrule and where guide pins are proximate to a locking feature of the connector, in accordance with some embodiments discussed herein;

FIG. 8B is a cross sectional view of the system illustrated in FIG. 8A, in accordance with some embodiments discussed herein;

FIG. 9A is a perspective view of a system for aligning a substrate with an optical fiber where guide pins have been received within a connector and a ferrule and where guide pins are engaged with a locking feature of the connector, in accordance with some embodiments discussed herein;

FIG. 9B is a cross sectional view of the system illustrated in FIG. 9A, in accordance with some embodiments discussed herein;

FIG. 10A is a side view of an example guide pin, in accordance with some embodiments discussed herein;

FIG. 10B is a close-up view of the guide pin of FIG. 10A where a capture feature of the guide pin may be seen, in accordance with some embodiments discussed herein;

FIG. 10C is a schematic side view of a guide pin, in accordance with some embodiments discussed herein;

FIG. 10D is a schematic, cross-sectional view of a system for aligning a substrate with an optical fiber, in accordance with some embodiments discussed herein;

FIG. 11 is an exploded view illustrating components that may be provided within a connector, in accordance with some embodiments discussed herein; and

FIG. 12 is a flow chart illustrating operations that may be performed to align a substrate with an optical fiber, in accordance with some embodiments discussed herein.

### DETAILED DESCRIPTION

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

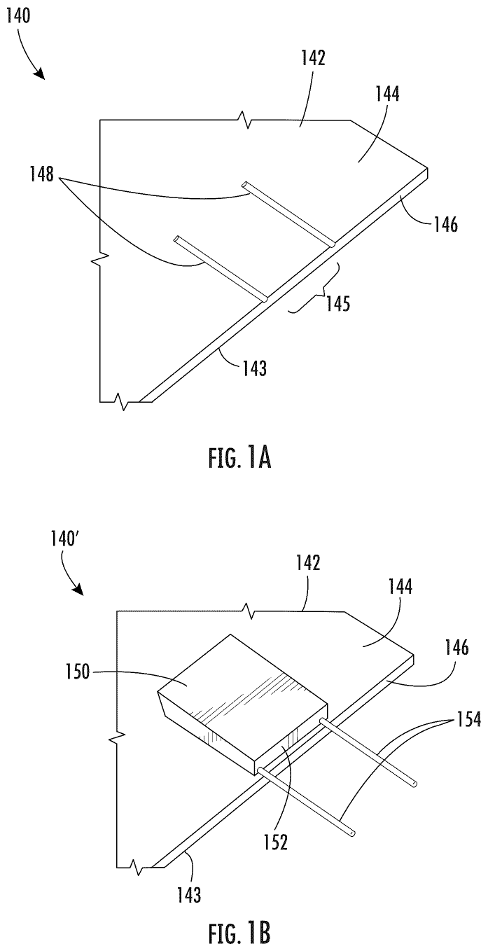

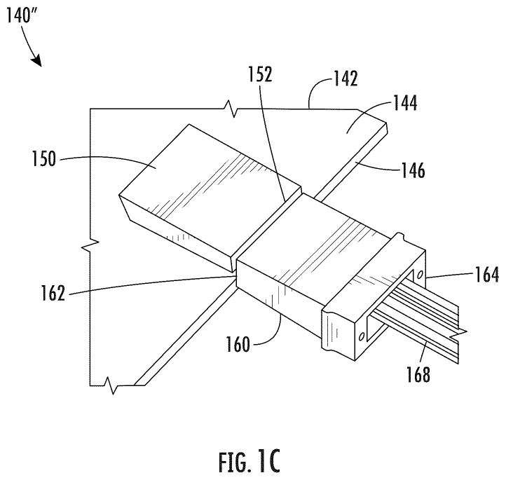

As noted above, improvements are desired to previous approaches for forming connections between a substrate and one or more optical fibers. Embodiments discussed herein provide systems and components that are easy to manufacture and easy to use, along with corresponding methods. FIGS. 1A-1C illustrate a substrate that may be used.

FIG. 1A is a perspective view of a portion of a substrate 140. This substrate 140 may comprise one or more waveguides (e.g., optical waveguides). These waveguides may be subsurface or surface waveguides. The substrate 140 may also comprise a substrate body 142. This substrate body 142 may comprise, for example, glass, silicon, fused silica, polymer, organic laminate. This substrate body 142 may have an upper surface 144, an edge 146, and a bottom surface 143. The substrate body 142 may also comprise two receiving features 148. These receiving features 148 are each configured to receive and also removably or permanently connect to the first end of a guide pin 154 (shown in FIG. 1B). In some embodiments, the guide pin 154 may be permanently connected to the receiving feature 148 using adhesive. Alternatively, the guide pin 154 may be removably or permanently connected to the receiving feature without adhesive (e.g., via a compression fit or other connection means). A second end for the guide pins 154 extends outwardly from the substrate body 142.

The receiving features 148 may be provided at the upper surface 144 of the substrate body 142. The receiving features 148 may be provided as a recess within the substrate body 142, and these recesses may take various shapes. For example, the recesses may have a semi-circular shape, a rectangular shape (e.g., form trenches), a triangular shape, etc. In some embodiments, the shape of the receiving features 148 matches the shape of guide pins 154 that the receiving features 148 are configured to be used with. Receiving features 148 may be separated by a distance 145. The positioning of the receiving features 148 may be configured to enable appropriate alignment between the substrate body 142 and a connector 160 for one or more optical fibers 168 (shown in FIG. 1C). In some embodiments, the receiving features 148 may be provided on a separate component (e.g. an attachment), and the substrate may be configured to receive and also removably or permanently connect to the attachment.

FIG. 1B is a perspective view of a substrate 140′. The substrate 140′ comprises a guide pin 154 received in each receiving feature 148. Additionally, a cover 150 is provided having an end face 152. Recesses may be provided within the cover 150 where guide pins 154 may be at least partially received. These recesses may extend from a central portion of the cover 150 to the end face 152.

FIG. 1C is a perspective view of a substrate 140″, where the guide pins 154 (shown in FIG. 1B) are received within a connector 160. As illustrated, optical fiber(s) 168 may be received within the connector 160. In some embodiments, the connector 160 may removably or permanently connect with the optical fiber(s) 168 so that the movement of the optical fiber(s) 168 is at least partially restrained. Connector 160 may comprise one or more guide holes 164. These guide holes 164 may extend from one side of the connector 160 to the other in some embodiments, but the guide holes 164 may instead extend only partially into the connector 160. A second end for the guide pins 154 extends outwardly from the substrate body 142, and the second end of a guide pin may be received within a guide hole 164 (that described connection is hidden by the connector 160). In some embodiments, when the guide pin is received within the guide hole 164, the movement of the substrate 140 may be constrained relative to the connector 160.

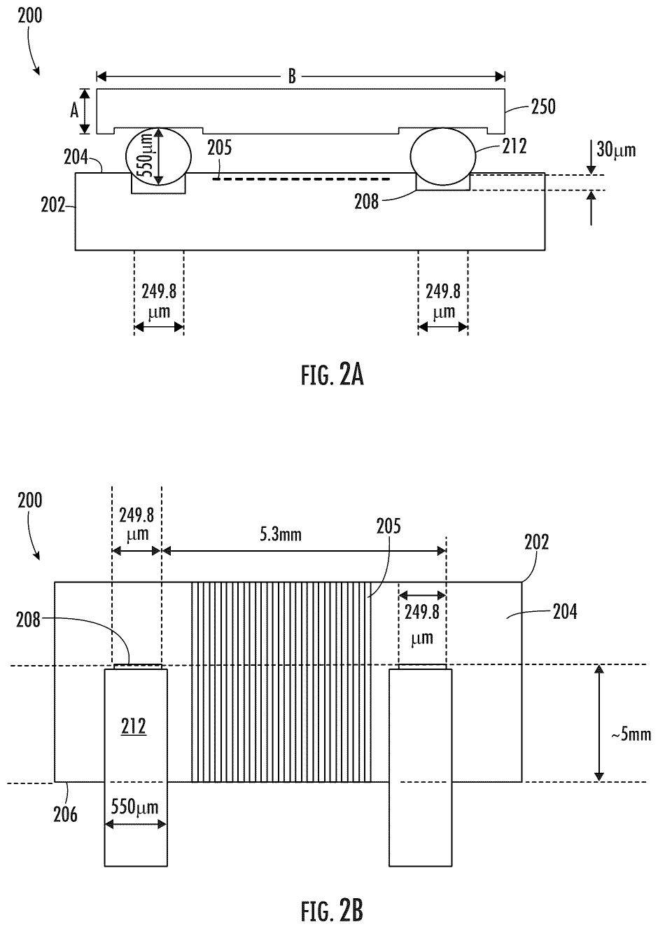

The substrate may be provided with dimensions to permit the accurate and reliable alignment of the substrate with the connector. This may in turn permit the waveguides within the substrate to each be accurately aligned with an optical fiber. Each optical fiber may, in some embodiments, be connected to a single waveguide within the substrate, and, in some embodiments, a plurality of optical fibers may align with a plurality of waveguides. FIGS. 2A-2B illustrate some of these dimensions in an example embodiment. FIG. 2A is a side view of a substrate 200 and guide pins 212, and FIG. 2B is a top view of the substrate 200 and the guide pins 212 of FIG. 2A. The substrate 200 comprises one or more optical waveguides 205. The substrate 200 also comprises a substrate body 202 having an upper surface 204. The substrate body 202 comprises two receiving features 208. The receiving features 208 are configured to receive a guide pin 212.

These receiving features 208 may be trenches that are formed at the upper surface 204. It may be difficult to maintain the depth of a trench within the tolerances required to appropriately align the substrate 200 with the connector 160 (FIG. 1C). The depth of the trench may be formed with low tolerances, but approaches for accomplishing this may be costly. By contrast, the width of the trench may be maintained at low tolerances in a cost-effective manner. Using laser ablation (e.g. using a nanosecond (ns), picosecond (ps), or femtosecond (fs) pulsed laser), the position of the side edges may be provided with sub-micron accuracy in a cost effective manner. Consequently, where a trench is used, the trench may comprise two side edges and a bottom surface, and the trench may be configured such that a guide pin 212 rests against the two side edges without contacting the bottom surface. An example of this is illustrated in FIG. 2A. With this approach, the positioning of the guide pin 212 will be effectively controlled by the side edges of the trench. The bottom surface will not be configured to come into contact with a guide pin 212, so the trench may be formed while using higher tolerances for the trench depth. Thus, trenches may be reliably formed in a cost-effective manner. In some embodiments, the trenches may be formed using a laser based approach.

Laser ablation also may be conducted for a variety of materials, and it may use a focused pulsed laser beam to remove small fractions of the substrate material to form micropatterns on the substrate. Laser ablation also provides a green approach as toxic chemicals and reagents need not be used.

In some embodiments, the receiving feature is a V-groove. The V-groove comprises two side walls with an angle of 30 degrees or larger. The V-groove is configured so that a guide pin will rest against the two side walls without contacting the bottom edge or surface. The V-grooves may be formed using an etching or machining or laser approach.

In some embodiments, the guide pins may be provided having a thickness of 550 μm, the receiving feature 208 may be provided in the form of a trench having a trench width of 249.8 μm, and the trench may have a depth of 30 Additionally, the trench may comprise a length of approximately 5 mm to permit approximately 5 mm of the guide pin to be received. The trenches may be offset at 5.3 mm increments. This offset may be measured from a side edge of a trench to the same respective side edge of an adjacent trench as shown in FIG. 2B. However, these dimensions may change in other embodiments.

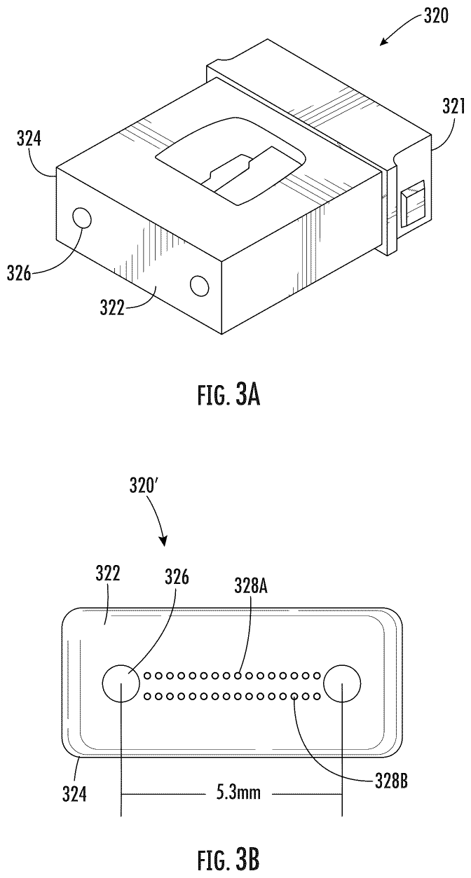

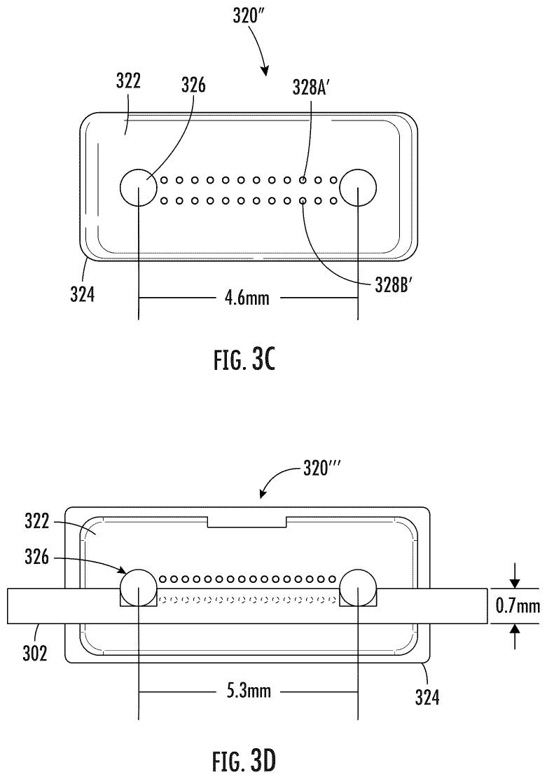

In some embodiments, a ferrule may be used to assist in aligning the waveguides within a substrate with an optical fiber. FIGS. 3A-3D provide views of different ferrules that may be used in certain embodiments. FIG. 3A is a perspective view of a ferrule 320. This ferrule 320 may be provided as part of the connector 160 (FIG. 1C) in some embodiments, but the ferrule 320 may be considered a separate component from the connector 160 in other embodiments. The connector 160 and the ferrule 320 may be configured so that the ferrule 320 may be partially or fully received within the connector 160. The ferrule 320 includes a body 324, a rear end 321, and a front end 322. The ferrule may also have guide holes 326 for receiving guide pins 154 (FIG. 1B) or 212 (FIGS. 2A-2B) extending through the body 324 between the rear end 321 and the front end 322. A suitable number of guide holes 326 may be provided, and the guide holes 326 may be provided in any suitable pattern. Guide holes 326 may extend through the front end 322 to expose terminated and polished ends of optical fibers 168 (FIG. 1C) within the connector 160 (FIG. 1C).

FIGS. 3B and 3C are end elevational views of a ferrule 320′, 320″ similar to the ferrule 320 illustrated in FIG. 3A. These views allow the front end 322 of the respective ferrule 320′, 320″ to be seen. As shown, guide holes 326 may extend from the front end 322 into the body 324 of the ferrules 320′, 320″. In various implementations, any suitable number of optical fiber bores and any suitable spacing between alignment holes may be provided. In both FIG. 3B and FIG. 3C, two rows of optical fiber bores 328A, 328B, 328A′, 328B′ are provided. Although multiple rows of optical fiber bores are shown in FIGS. 3B and 3C, in certain embodiments only a single row of optical fiber bores may be populated with optical fibers and/or used to interface with waveguides integrated within a substrate 200 (FIG. 2A-2B) (e.g., including electrically conductive vias) as disclosed herein, since such a substrate may have optical waveguides arranged at one depth therein. The ferrules may comprise a multi-fiber optical connector.

The ferrules 320′, 320″ illustrated in FIG. 3B and FIG. 3C have different numbers of optical fiber bores 328A, 328B, 328A′, 328B′ and different spacing between alignment holes 326. As illustrated in FIG. 3B, the alignment holes 326 are offset 5.3 mm away from each other. By contrast, in FIG. 3C, the alignment holes 326 are offset 4.6 mm away from each other. Further, the ferrule 320′ illustrated in FIG. 3B has sixteen optical fiber bores 328A, 328B provided on each row so that thirty-two optical fiber bores 328A, 328B are provided in total. By contrast, the ferrule 320″ illustrated in FIG. 3C has twelve optical fiber bores 328A′, 328B′ provided on each row so that twenty-four optical fiber bores 328A′, 328B′ are provided in total.

FIG. 3D is a schematic view illustrating a ferrule 320′″ with a substrate 302 positioned against the ferrule 320″. As shown, the substrate 302 may have a thickness of approximately 0.7 mm. The substrate 302 may be configured to receive and also removably or permanently connect with guide pins, and these guide pins may be received within alignment holes 326. Notably, the substrate 302 covers some of the fiber bores (which are shown dashed out) as they would be aligned with corresponding waveguides within the substrate 302.

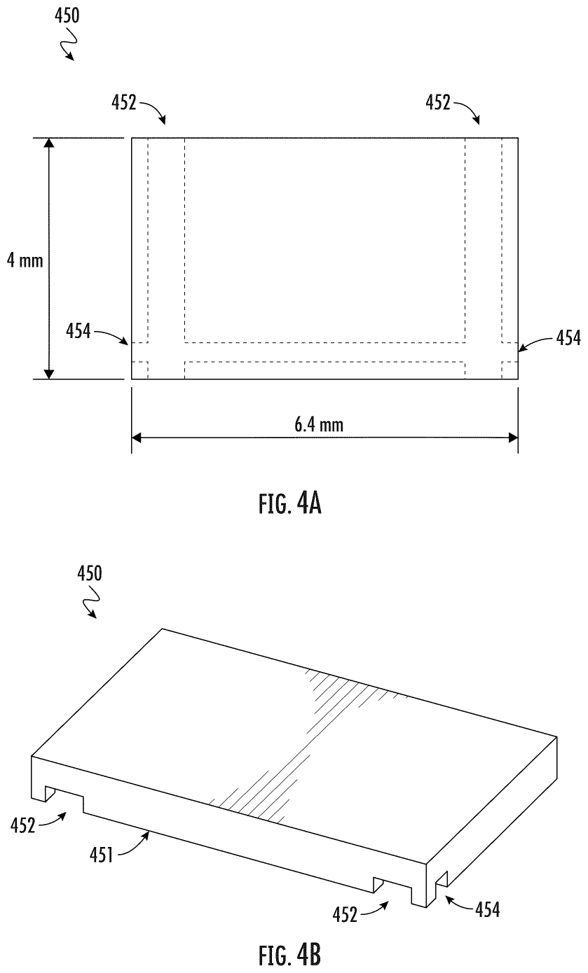

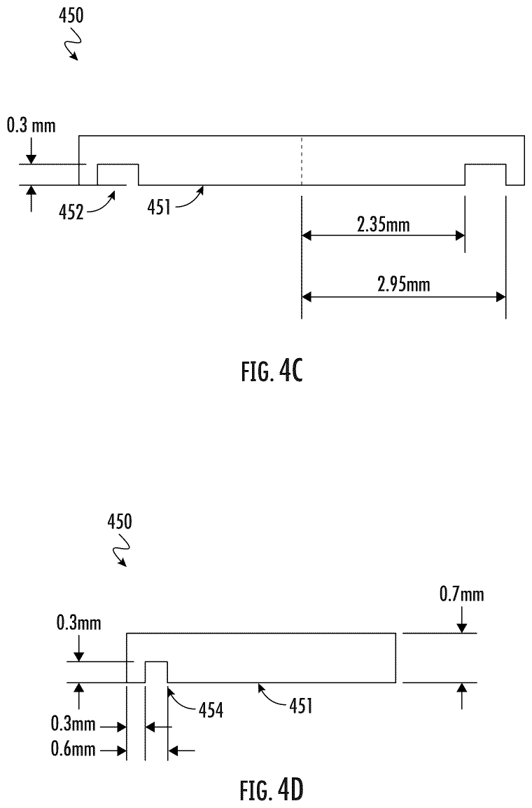

To assist with connecting a guide pin to the appropriate position on a substrate or a substrate body of the substrate, a cover (e.g., an attachment) may be provided that may be positioned above the guide pin(s). FIGS. 4A-4D illustrate various views of a cover 450 that may be used. FIG. 4A is a bottom schematic view of a cover 450 that may be used in conjunction with the receiving features 148 (FIG. 1A), 208 (FIG. 2A, 2B) of the substrate 140, 200 to removably or permanently connect with two guide pins. FIG. 4B is a perspective view of the cover 450, FIG. 4C is a front view of the cover 450, and FIG. 4D is a side view of the cover 450.

The cover 450 may be designed to press and hold guide pins 154 (FIG. 1B) or 212 (FIGS. 2A-2B) in the appropriate position. The cover 450 may, for example, comprise plastic or glass material. In some embodiments, a cover 450 and a substrate body 202 (FIGS. 2A-2B) of a substrate 200 (FIGS. 2A-2B) are made of materials having a similar coefficient of thermal expansion (CTE), but the cover 450 and a substrate body 202 may have dissimilar CTE properties in other embodiments. In some instances, the cover 450 and the substrate body 202 (FIGS. 2A-2B) are made of the same material and have the same coefficient of thermal expansion (CTE). Where a CTE mismatch is present, some components may tend to expand or shrink in size disproportionally in very warm or very cold temperatures, which may lead to misalignment of the components. By providing a cover 450 and a substrate body 202 (FIGS. 2A-2B) with similar or the exact same CTE, the reliability of the assembly as a whole may be improved.

In some embodiments, an adhesive may be used to permanently connect the cover 450, the guide pins 212 (FIGS. 2A-2B), and/or the substrate body 202 (FIGS. 2A-2B) of the substrate 200 (FIGS. 2A-2B) together. This adhesive may comprise a material having a CTE that differs from the CTE for materials provided in the cover 450, the guide pins 212 (FIGS. 2A-2B), and the substrate body 202 of the substrate. Thus, in some embodiments, only a small amount of adhesive is used. For example, an adhesive layer may be provided having a thickness of less than 100 μm. In some embodiments, no adhesive is used. By using only a small amount of adhesive, the reliability of the assemblies may be improved. A CTE mismatch may be less relevant, for example, where the assembly is only used indoors.

The cover 450 may be approximately 6.4 mm in width (measured from left to right in FIG. 4A). The cover 450 may also be 4 mm in length (measured from bottom to top in FIG. 4A). The cover 450 may comprise two primary cover trenches 452. These primary cover trenches 452 may be formed on a bottom surface 451 of the cover 450, and these primary cover trenches 452 may span along the length of the cover 450. As illustrated in FIG. 4A, the primary cover trenches 452 may span the entire length of the cover 450. However, in other embodiments, the primary cover trenches 452 may extend only partially into the cover 450.

As illustrated in FIG. 4C, primary cover trenches 452 may be approximately 0.6 mm in width (measured from left to right in FIG. 4C) and may be approximately 0.3 mm in depth (measured from bottom to top in FIG. 4C). The primary cover trenches 452 may have two side edges, and the side edge positioned closer to the center of the cover 450 may be positioned approximately 2.35 mm away from the center of the cover 450 in some embodiments.

As illustrated in FIG. 4D, secondary cover trenches 454 may be provided at the bottom surface 451 of the cover 450. Secondary cover trenches 454 may have two side edges. The side edge positioned farther away from the center of the cover 450 may be approximately 0.3 mm away from a side surface of the cover 450. The secondary cover trench 454 may be approximately 0.3 mm in width (measured from left to right in FIG. 4D). The secondary cover trenches 454 may also have a depth (measured from bottom to top in FIG. 4D) of approximately 0.3 mm.

While specific dimensions are described above, a cover 450 may be provided with different dimensions in other embodiments. These dimensions may be provided to meet the overall packaging specifications required for a given application.

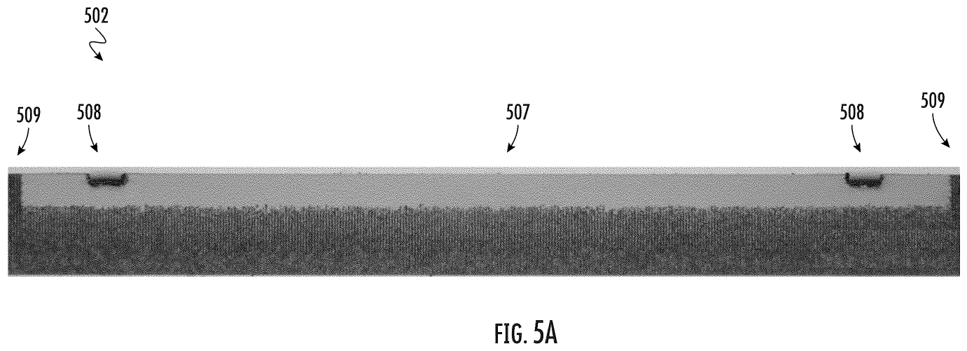

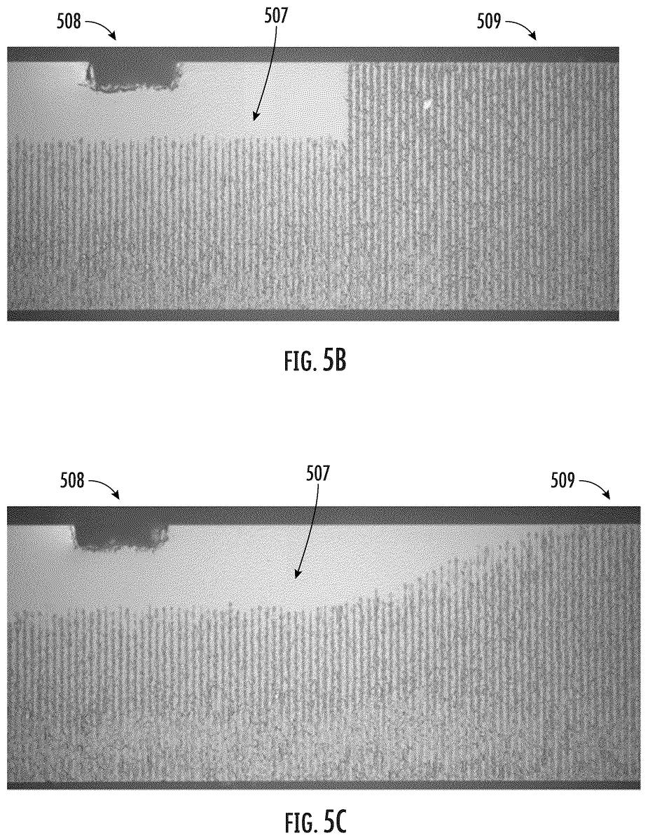

In some embodiments, the substrate may comprise an optical area, and this optical area may be configured to receive and hold optical waveguides. Controlling the dimensions of this optical area relative to a ferrule and controlling the transition from the optical area may be important considerations. FIG. 5A is a side view of a substrate 502 where an optical area 507 may be seen. As illustrated, the substrate 502 comprises two receiving features 508. In this embodiment, the receiving features 508 are provided as trenches. The trenches are approximately 249.8 μm in width. FIG. 5A also illustrates an optical area 507 and a non-optical area 509. A ferrule (e.g. ferrule 320 in FIG. 3A) may be urged against the substrate 502 at the optical area 507. Thus, the end-face of an optical fiber received within the ferrule may be urged against an optical waveguide of the one or more optical waveguides in the substrate 502. The optical area 507 width (measured from left to right in FIG. 5A) may be greater than 6.5 mm so that the width of the optical area 507 is greater than the width of the ferrule. The optical area 507 may be partially nano-perforated, and other non-optical areas 509 may be fully nano-perforated during the substrate laser singulation process.

FIGS. 5B and 5C illustrate different approaches for transitioning from partial nano-perforation in an optical area 507 to full nano-perforation in non-optical areas 509. In FIG. 5B, this change occurs as a step function, where the transition occurs immediately and is not spread out from left to right. In FIG. 5C, this change occurs adiabatically so that the transition is spread out from left to right. The change from full-nano-perforation in the non-optical area 509 to partial nano-perforation in the optical area 507 may be achieved by stepping the laser focus or adiabatic change of laser focus.

By providing an optical area 507 that is wider than the ferrule width, any change from partial nano-perforation to full perforation will occur outside of any overlap area between a ferrule and an optical area. This reduces the risk of protruded features which could prevent physical contact between an optical fiber and the integrated waveguides. This may also be beneficial to reduce waviness of waveguides and to reduce the number of defects.

Various embodiments of the present invention described herein provide a substrate having one or more guide pins removably or permanently connected on the substrate. Some example embodiments include guide pins that comprise a capture feature that is configured to engage with a locking feature within a connector to restrain the connector and ensure proper alignment of the optical fibers with the waveguides in the substrate. For example, the capture feature may prevent the guide pins from retracting along a lengthwise axis of the guide pins when the capture feature and the locking feature are engaged. Further, the reception of a guide pin within a hole within a ferrule or connector may restrict movement of the guide pin in other dimensions. In this way, the engagement between the capture feature and the locking feature may cause the optical fiber to be restrained from movement relative to the substrate. In some embodiments, the capture feature and locking feature may be easily disengaged so that guide pins may be retracted.

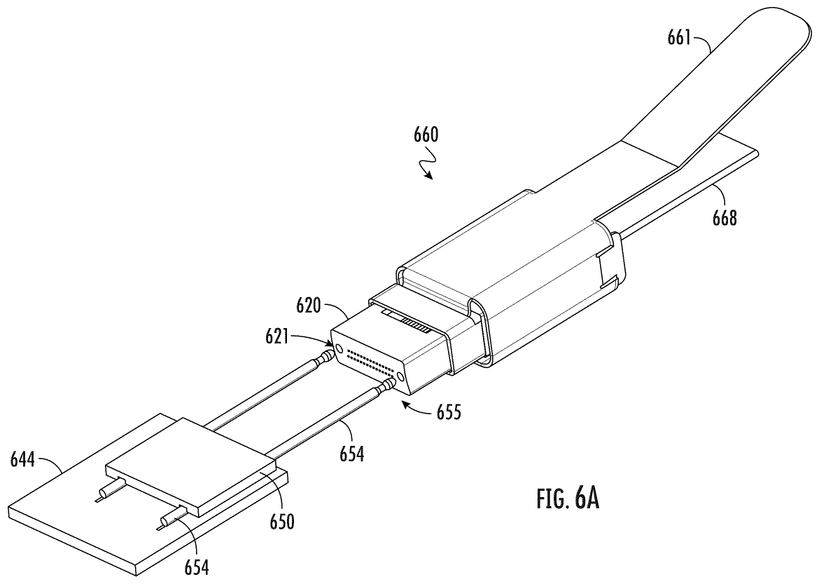

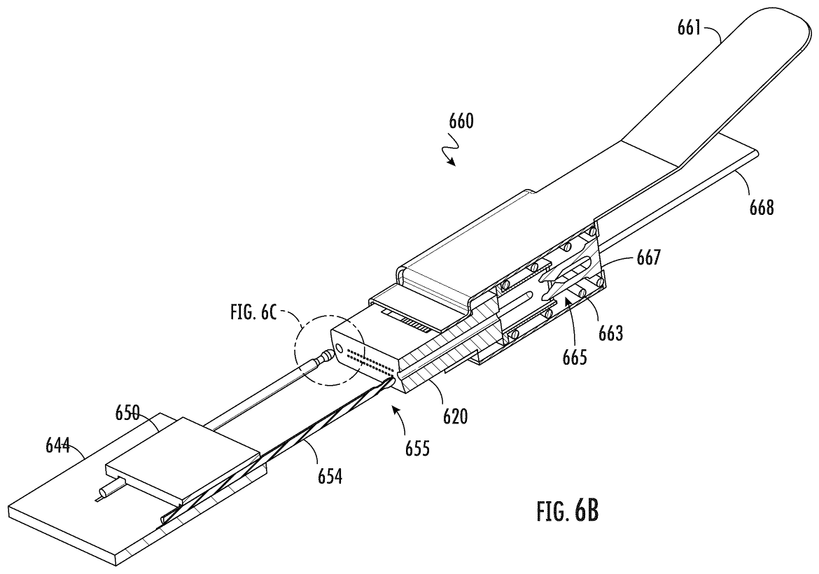

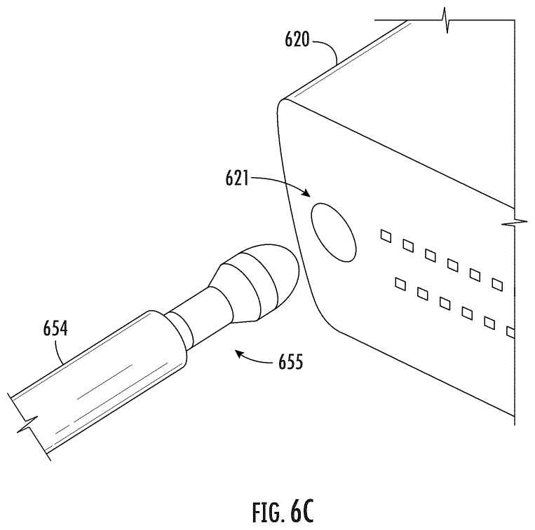

These features and other features of various embodiments are more readily understood in reference to FIGS. 6A-6C, 7A-7B, 8A-8B, 9A-9B. FIGS. 6A-6C illustrate various views of a system when guide pins have not yet been received within a ferrule.

FIG. 6A is a perspective view of an example system for aligning a substrate with an optical fiber where the guide pins have not yet been received in the connector or ferrule. FIG. 6B is a cross sectional view of the system illustrated in FIG. 6A. FIG. 6C is an enhanced view of the system illustrated in FIG. 6B where the guide pin and a hole within a ferrule may be seen.

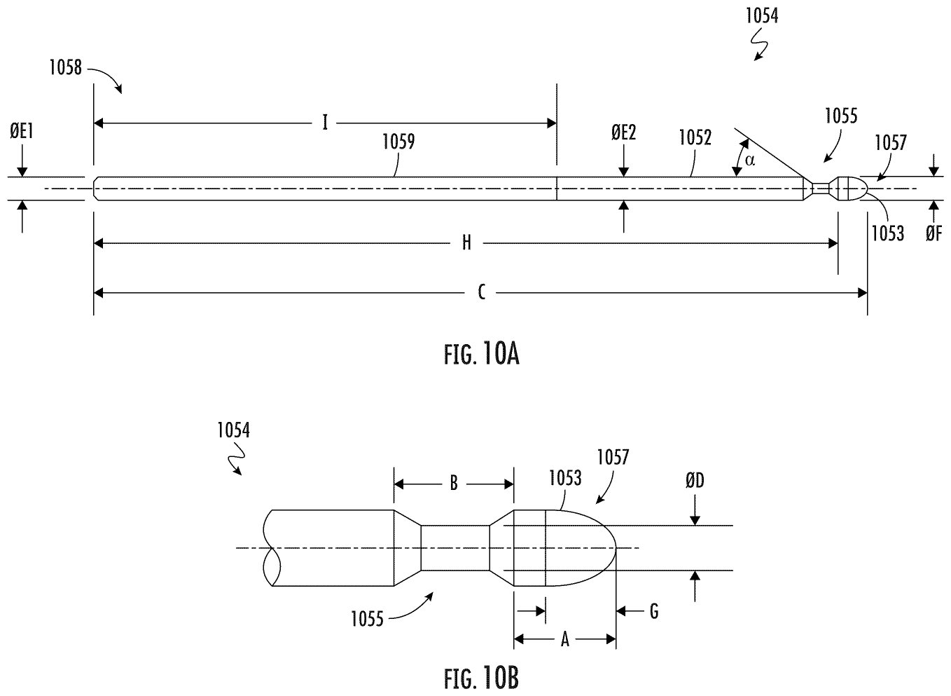

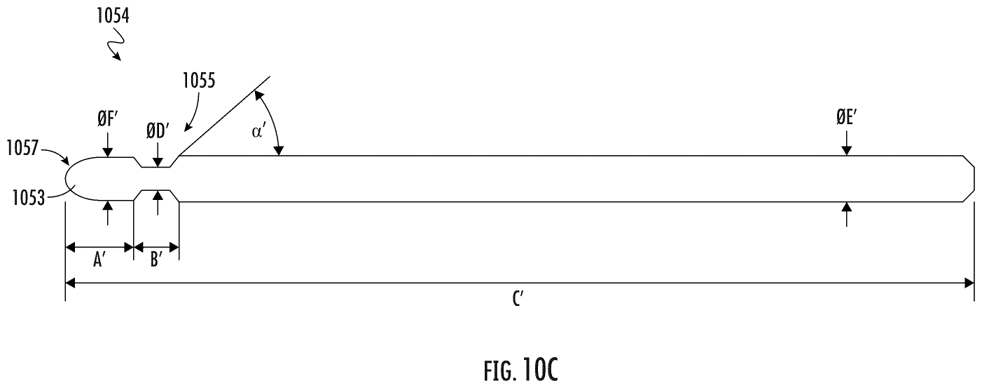

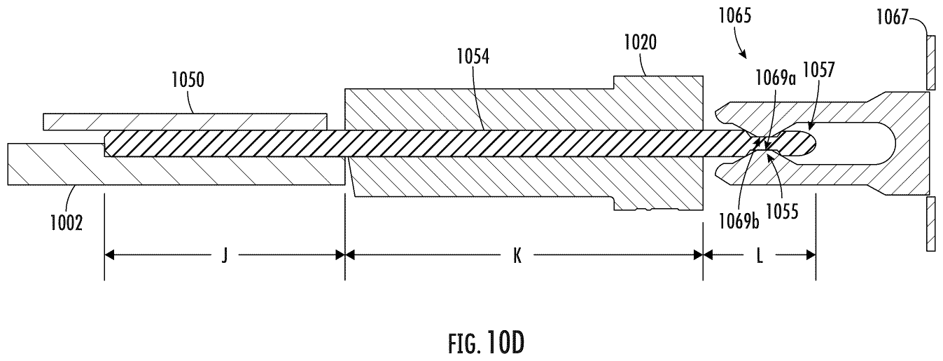

As illustrated in FIG. 6A, a substrate 644 is provided. This substrate 644 may comprise a substrate body having a receiving feature. The substrate 644 may comprise one or more waveguides. At least one guide pin 654 is also provided, and these guide pins 654 comprise a first end and a second end. The receiving feature may be configured to receive and also removably or permanently connect the first end of the guide pins 654. The first end of the guide pins 654 may be removably or permanently connected to the substrate 644 using a cover 650. The second end of the guide pins 654 may extend outwardly from the substrate body, and a capture feature 655 may be provided proximate to the second end of the guide pins 654 (further detail regarding example capture features is described with respect to FIGS. 10A-C).

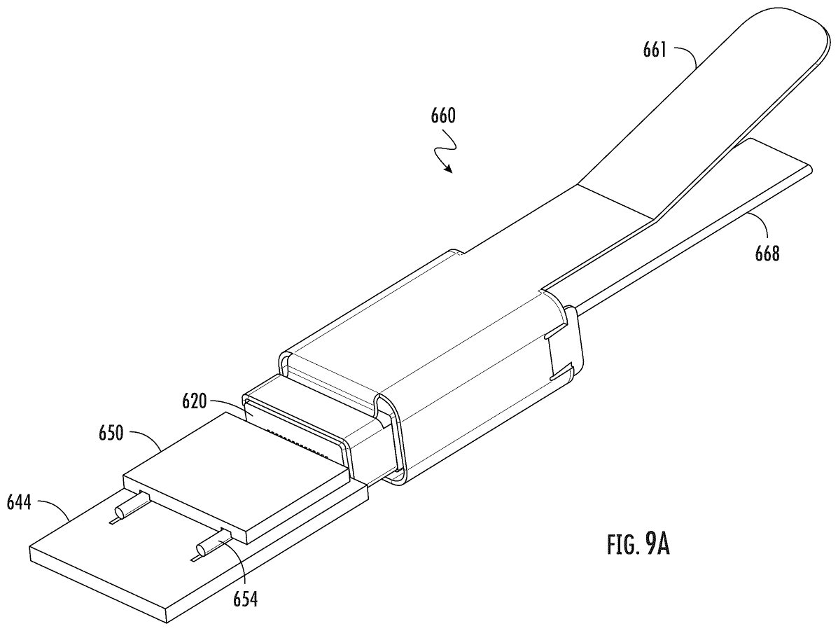

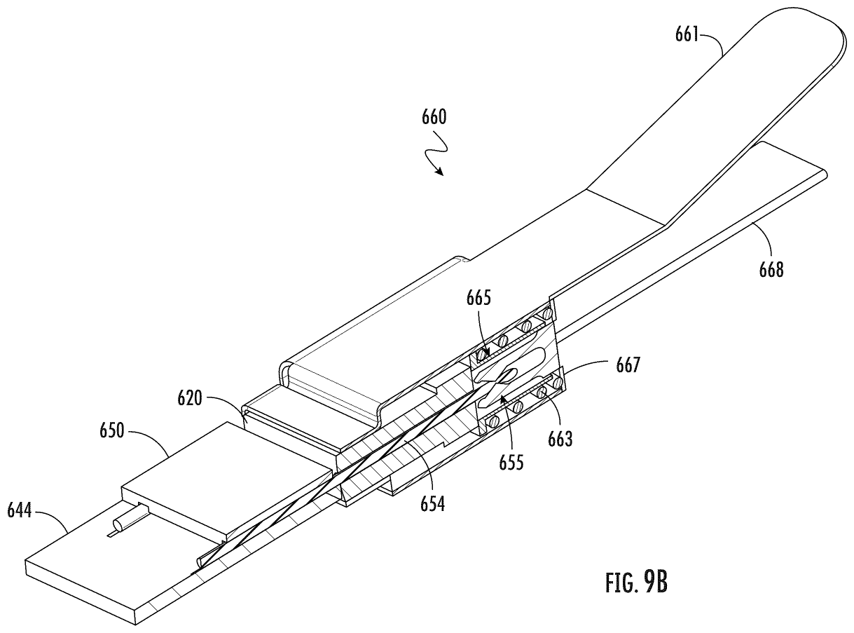

Optical fibers 668 and a connector 660 are also provided. The connector 660 may be configured to receive the optical fibers 668 (e.g., be associated with one or more optical fibers attached to a ferrule that is movably retained by the connector, such as described herein). As illustrated in FIG. 6B, a receiver portion 667 may comprise a locking feature 665. As shown, the receiver portion 667 defines a recess where a guide pin 654 may be received. In one embodiment, locking feature 665 may be provided within the receiver portion 667 by reducing the thickness of this recess. This will allow the locking feature 665 to engage with a capture feature 655 of a guide pin 654. However, the locking feature 665 may take different forms in other embodiments. For example, the locking feature 665 may be provided within a receiver portion 667 by increasing the thickness of this recess or the receiver portion 667 may comprise a small pin that is configured to engage a hole within the guide pin 654. When the capture feature 655 is engaged with the locking feature 665, this may help cause the alignment of the optical fiber 668 with the waveguides and restrain movement of the optical fiber 668 relative to the substrate 644 (such as described with respect to FIGS. 9A-9B).

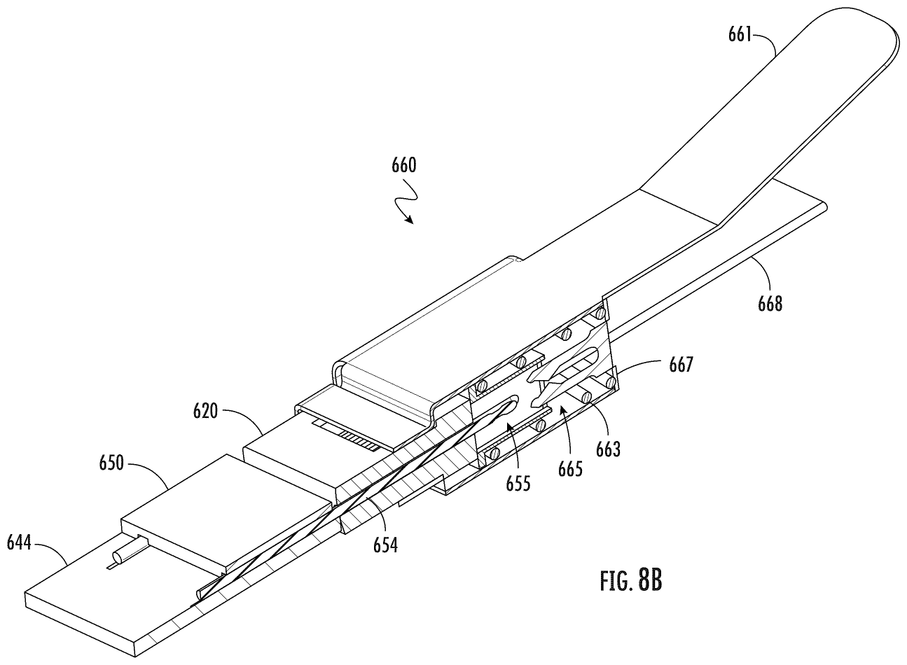

As illustrated in FIG. 6B, a ferrule 620 and a spring 663 may also be provided. The ferrule 620 may be received within the connector 660, and the ferrule 620 may be positioned between the substrate 644 and the spring 663. The ferrule 620 may be permitted to shift or “float” within the connector 660. The spring 663 may also be received within the connector 660. This spring 663 may be received between a back interior wall of the connector 660 and the ferrule 620. The ferrule 620 may be configured to receive the optical fiber 668 and the at least one guide pin 654. When the guide pin(s) 654 are captured by the locking feature 665, the spring 663 generates a force against the ferrule 620 to urge the ferrule 620 towards the substrate 644 (shown in FIGS. 8A-9B). In some embodiments, the spring 663 may be configured to provide a force in the range of about 2 to about 20 N, and the spring 663 may be configured to bring the optical fiber 668 into physical contact with the one or more waveguides (e.g. optical waveguides) of the substrate 644.

FIG. 6C illustrates an enhanced view of the capture feature 655 and the ferrule 620. As shown, the ferrule 620 may comprise one or more holes 621. These holes 621 are configured to receive the guide pin 654 when the hole 621 and the guide pin 654 are aligned, such as shown in FIG. 6C. The holes 621 may extend completely through the ferrule 620, allowing the guide pin 654 to extend to the receiver portion 667 of the connector 660.

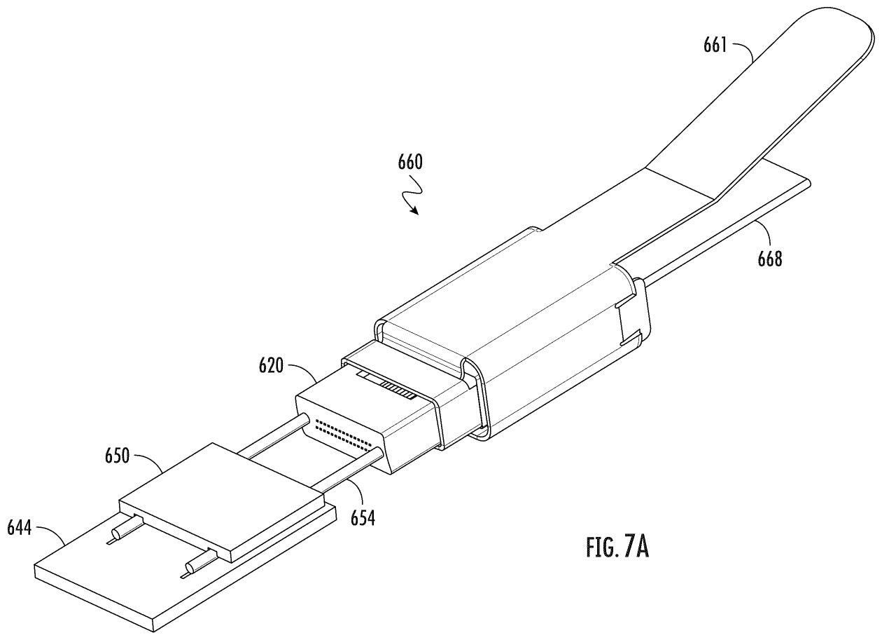

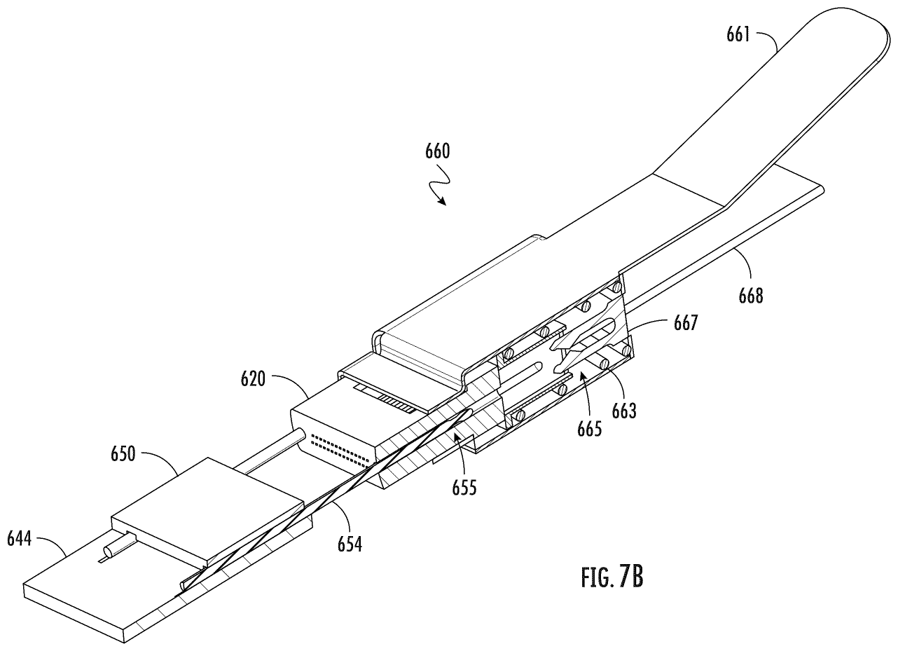

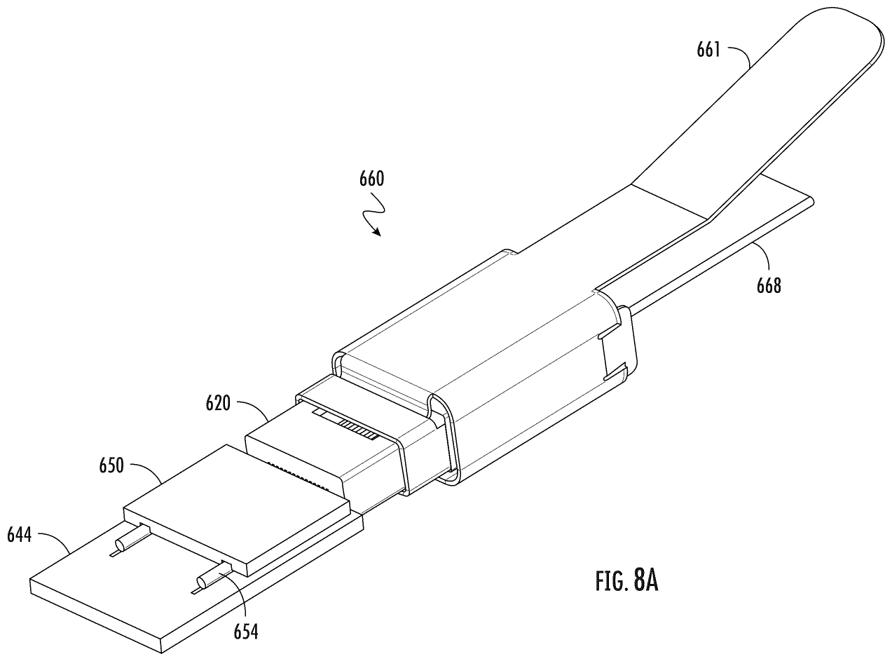

FIGS. 7A-7B illustrate various views of the system shown in FIGS. 6A-6C where the guide pins 654 have been partially received in the connector 660 and ferrule 620. FIG. 7A is a perspective view, and FIG. 7B is a cross sectional view allowing internal components to be seen. As may be best seen in FIG. 7B, the guide pins 654 are received within the holes 621 (FIG. 6C) of ferrule 620. As shown, the spring 663 is in the same position in FIG. 7B that it was in FIG. 6B and has not yet been compressed.

FIGS. 8A-8B illustrate various views of the system shown in FIGS. 6A-6C where the guide pins 654 have been further received into the connector 660 and ferrule 620 (such as with respect to FIGS. 7A-7B). FIG. 8A is a perspective view, and FIG. 8B is a cross sectional view allowing internal components to be seen. As may be best seen in FIG. 8B, the guide pin 654 has been shifted closer to the receiver portion 667 of the connector in FIG. 8B as compared to FIG. 7B. In FIG. 8B, the ferrule 620 has just contacted the substrate 644. The spring 663 is in the same position in FIG. 8B that it was in FIGS. 6B and 7B and has not yet been compressed. As the guide pin 654 is shifted further into the connector 660, the substrate 644 will urge the ferrule 620 towards the receiver portion 667 of the connector 660. As the ferrule 620 is urged towards the receiver portion 667, the spring 663 is compressed. The compressed spring 663 may ensure that the ferrule 620 is positioned against the substrate 644.

FIGS. 9A-9B illustrate various views of the system shown in FIGS. 6A-6C where the guide pins 654 have been fully received in the connector 660 and ferrule 620. FIG. 9A is a perspective view, and FIG. 9B is a cross sectional view allowing internal components to be seen. As illustrated, the capture feature 655 of the guide pin 654 has been received within the receiver portion 667 of the connector 660 using a locking feature 665. The engagement between the capture feature 655 and the locking feature 665 may provide sufficient force to withstand the force of the spring 663, which is configured in this compressed state to urge the ferrule 620 towards the substrate 644. Thus, the engagement between the capture feature 655 and the locking feature 665 may restrain movement of the guide pin(s) 654. The ferrule 620 may be positioned entirely within the connector 620 when the capture feature 655 is engaged with the locking feature 665 (e.g., consider the position of the connector 660 with respect to the ferrule 620 between FIGS. 8B and 9B). Notably, additional detail regarding the engagement of the capture feature and the locking feature is provided with respect to FIG. 10D.

In some embodiments, the system may be configured to enable release of the capture feature of the guide pin, so as to enable detachment of the connector 660 (and separation of the optical fibers and the waveguides of the substrate). In this regard, in the illustrated embodiment, a finger tab 661 may be provided to enable such release to occur. The finger tab 661 may provide an easy approach for disengaging the capture feature 655 of the guide pin 654 from the locking feature 665 so that the substrate 664 may be separated from the connector 660 as desired by a user. The finger tab 661 may be configured to be grasped by a user such as to allow the user to impart a retraction force to disengage the connector from the guide pin. Upon application of enough retraction force, the locking feature 665 of the receiver portion 667 may disengage from the capture feature 655 of a guide pin 654. This may allow the guide pin 654 to be retracted from the receiver portion 667 and the connector 660. This finger tab 661 is positioned near the top of the connector 660 in FIGS. 9A-9B, but the finger tab 661 may be positioned at other locations. For example, the finger tab 661 may be implemented near the bottom of the connector 660.

As discussed herein, the guide pins of the system may be provided having a capture feature. In this regard, the guide pins may be provided with appropriate dimensions so that the guide pins may be configured to engage with a locking feature in a connector. FIGS. 10A-10D illustrate example guide pins and dimensions for the guide pins. FIG. 10A is a side view of a guide pin. FIG. 10B is an enhanced view of the guide pin of FIG. 10A where a capture feature of the guide pin may be seen. FIG. 10C is a schematic side view of a guide pin, and FIG. 10D is a schematic, cross-sectional view of a portion of a system for aligning a substrate with an optical fiber.

In FIG. 10A, an example guide pin 1054 is illustrated. The guide pin 1054 defines a first end 1058 and a second end 1057, and the guide pin 1054 comprises a capture feature 1055 proximate the second end 1057. The capture feature 1055 is a groove in this embodiment. In some embodiments, such as the one illustrated in FIG. 10A, the guide pin 1054 may be symmetrical about an axis.

In FIG. 10A, the embodiment comprises a first section 1059 and a second section 1052. The first section 1059 may have a diameter ØE1 that is slightly larger than the diameter ØE2 of the second section 1052. The first section may have a length I, and this length I may be approximately 11.3 mm±0.1 mm. The second section 1052 may comprise a length of approximately 6.125 mm±0.1 mm. In some embodiments, a fillet or chamfer may be provided at the transition between the first section 1059 and the second section 1052. The guide pin 1054 in FIG. 10C is slightly different from the guide pin 1054 of FIGS. 10A and 10B. Guide pin 1054 does not comprise a first section 1059 and a second section 1052. Instead, guide pin 1054 comprises only one section. In this regard, any number of sections may be used for a guide pin.

FIGS. 10A-10C illustrate various dimensions for the guide pins. In other embodiments, the dimensions may be altered. Example dimensions for the guide pins are illustrated below in Table 1.

TABLE 1
Example dimensions for guide pins

| | |
|---|---|
| Length A | 0.725 mm ± 0.1 mm |
| Length B | 0.85 mm ± 0.05 mm |
| Length C | 19 mm ± 0.1 mm |
| Diameter ØD | 0.33 mm ± 0.01 mm |
| Diameter ØE1 | 0.5485 mm ± 0.0005 mm |
| Diameter ØE2 | 0.53 mm ± 0.005 mm |
| Diameter ØF | 0.33 mm ± 0.01 mm |
| Length G | 0.5 mm ± 0.05 mm |
| Length H | 18.275 mm ± 0.01 mm |
| Length I | 11.3 mm ± 0.1 mm |
| Angle α | 30 deg. ± 1 deg. |

Lengths A and A′ indicate the distance from the capture feature 1055 to the extreme end of the second end 1057. Length A is approximately 0.725 mm±0.1 mm in the illustrated embodiment in FIG. 10B. However, in the embodiment illustrated in FIG. 10C, a tolerance of ±0.05 mm is used for the Length A′.

Length B and B′ indicate the length of the capture feature 1055. Length B is approximately 0.85 mm±0.05 mm in the illustrated embodiment in FIG. 10B, but length B may be approximately 0.87 mm±0.1 mm in the embodiment illustrated in FIG. 10C.

Length C and C′ indicate the total length of the guide pin 1054. In the embodiment illustrated in FIG. 10A, the length C may be approximately 19 mm±0.1 mm. However, in the embodiment illustrated in FIG. 10C, the length C′ may be approximately 16 mm±0.05 mm.

Diameters OD and OD′ indicate the smallest diameter of the capture feature 1055. In FIG. 10A, the diameter OD may be approximately 0.33 mm±0.01 mm. However, in FIG. 10C, the diameter OD′ may be approximately 0.34 mm±0.01 mm.

In FIG. 10A, diameter ØE1 indicates the diameter of the first section 1059, and length I indicates the length of the first section 1059. In the embodiment illustrated in FIG. 10A, diameter ØE1 is approximately 0.5485 mm±0.0005 mm, and length I is approximately 11.3 mm±0.1 mm. Further, diameter ØE2 indicates the diameter of the second section 1052, and diameter ØE2 may be approximately 0.53 mm±0.005 mm. The guide pin 1054 in FIG. 10C is different from the guide pin 1054 of FIGS. 10A and 10B. Guide pin 1054 does not comprise a first section 1059 and a second section 1052. Instead, guide pin 1054 comprises only one section extending from the capture feature 1055 to the second end, and diameter ØE′ indicates the diameter of this section. Diameter ØE′ may be approximately 0.5485 mm±0.0005 mm. Diameters OF and OF′ may be identical to the dimensions for ØE2 and ØE′ respectively.

The guide pin 1054 may comprise a head portion 1053 at the second end 1057. The head portion 1053 may have a rounded section, and Length G indicates the length of this rounded section. Length G is approximately 0.5 mm±0.05 mm in the embodiment illustrated in FIGS. 10A and 10B, and a similar length may be used in the embodiment illustrated in FIG. 10C. However, the head portion 1053 may comprise another shape. For example, the head portion may have straight, tapered edges, or the rounded section may be provided with different dimensions.

Length H indicates the length from the extreme end of the first end 1058 to the head portion 1053. In the embodiment illustrated in FIGS. 10A and 10B, length H may be approximately 18.275 mm±0.01 mm.

Angle α may serve as a chamfer angle for the capture feature 1055. Any value between 0 and 90 degrees may be used for the angle α, and the chamfer angle may be 0 degrees or 90 degrees so that no chamfer is provided at all. In some embodiments, the angle may fall within the range of about 25 degrees to about 45 degrees. In the embodiment illustrated in FIG. 10C, the angle α is 30 deg.±1 deg. This chamfer angle may be used on both sides of the capture feature to transition to the head portion 1053 and the second section 1052.

In FIG. 10B, the capture feature 1055 of the guide pin 1054 comprises a first portion in the form of the head portion 1053 that is proximate to the second end 1057. The capture feature 1055 may also comprise a second portion along the length B that is proximate to the second end 1057. The first portion may have an increased thickness relative to the second portion, the first portion being more proximate (e.g., closer) to the second end 1057 than the second portion. As illustrated in FIGS. 9A-9B and 10D, the first portion is configured to engage with the locking feature of the receiver portion to restrain the movement of the guide pins and the substrate.

FIG. 10D illustrates a schematic, cross sectional view of a guide pin and other components when the capture feature of the guide pin is engaged with the locking feature 1065 of the receiver portion 1067.

With consideration of FIGS. 8A-8B to FIGS. 9A-9B, as the guide pin 1054 is inserted further into the receiver portion 1067, the guide pin 1054 will interact with the locking feature 1065. Due to the head portion 1053 of the guide pin 1054 including a rounded section, the guide pin 1054 may cause the locking feature 1065 to temporarily enter an open state to enable further insertion of the guide pin 1054. For example, as the guide pin 1054 is inserted toward the teeth 1069a, 1069b of the locking feature 1065, the rounded section of the head portion 1053 may cause the teeth 1069a, 1069b to expand to cause the locking feature 1065 to temporarily enter the open state to enable further insertion of the guide pin 1054.

Once the head portion 1053 clears the teeth 1069a, 1069b, the bias of the locking feature 1065 may cause the teeth 1069a, 1069b to move back together to engage with the first (lower) portion such that the capture feature 1055 is prevented from being withdrawn from the locking feature 1065. In this regard, the head portion 1053 of the guide pin 1054 may be prevented from retracting away from the receiver portion 1067 because of the engagement between the capture feature 1055 and the teeth 1069a, 1069b of the locking feature 1065. In other embodiments, the locking feature 1065 and the capture feature 1055 may operate differently and may possess different geometries.

As illustrated in FIG. 10D, the guide pin 1054 may be positioned between a cover 1050 and a substrate 1002. The guide pin 1054 may also extend through a hole within a ferrule 1020. The dimensions discussed above may permit the guide pins to properly engage and disengage with the locking feature 1065 of the receiver portion 1067, and the dimensions also permit the guide pins 1054 to rest properly within the other components. However, the dimensions may be modified in other embodiments.

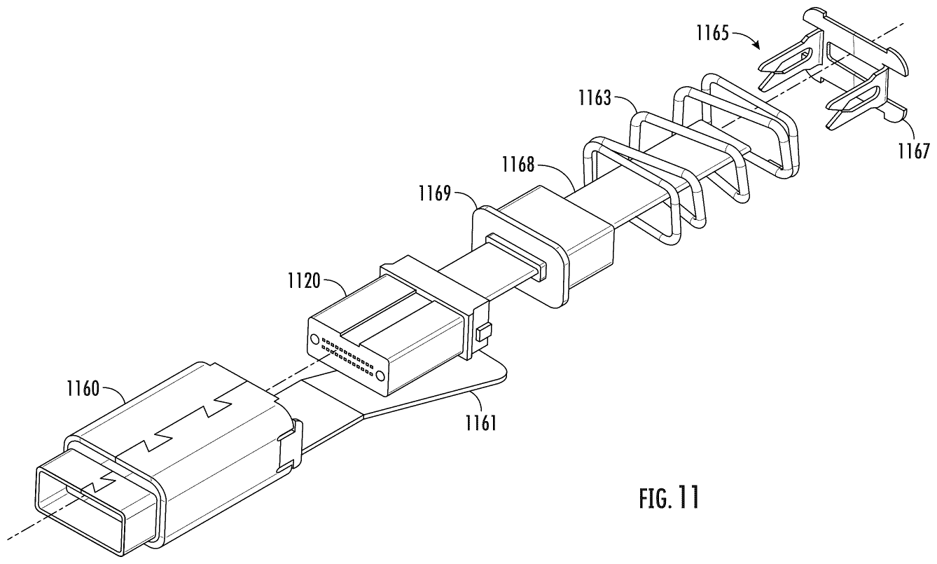

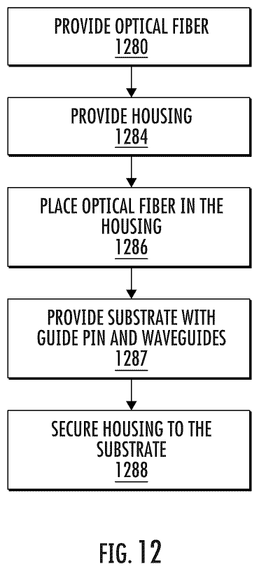

A connector for the optical fibers and ferrule may define a cavity that allows other components to be at least partially received within the connector. FIG. 11 is an exploded view illustrating components that may be provided within an example connector 1160. A ferrule 1120, optical fibers 1168, a spring guide 1169, a spring 1163, and a receiver portion 1167 having a locking feature 1165 are provided. The optical fibers 1168 may extend through recesses within the spring guide 1169, the spring 1163, and the receiver portion 1167, and the optical fibers 1168 may extend into a recess within the ferrule 1120. In the example embodiment illustrated in FIG. 11, the spring 1163 is positioned between the receiver portion 1167 and the spring guide 1169, and the spring guide 1169 is positioned between the ferrule 1120 and the spring 1163. Ferrule 1120 may comprise ribbon fibers, and these ribbon fibers may be glued in. The ferrule 1120 shown is a two-row MTP-16 ferrule, but other ferrules could be used. In some embodiments, a tension spring or a compression spring may be used for the spring 1163.

Receiver portion 1167 may serve as a pin fixture, receiving at least one guide pin. When the guide pins are removably or permanently connected to a substrate and urged towards the receiver portion 1167, the substrate may eventually contact the ferrule 1120. The guide pins may continue to be urged towards the receiver portion 1167 until the capture feature of the guide pins engages with the locking feature 1165 of the receiver portion 1167. In this capture state, the spring 1163 may urge the ferrule 1120 towards a substrate.

In some embodiments, the spring 1163 will urge the ferrule 1120 against the substrate and/or the spring 1163 may be configured to urge an end-face of the optical fiber 1168 received within the ferrule 1120 against one or more optical waveguides in the substrate. However, in some embodiments, the spring 1163 may be configured to urge the ferrule 1120 proximate to the substrate 1002 while leaving a gap between the ferrule 1120 and the substrate 1002 in other embodiments. Where the spring 1163 is configured to leave a gap, an anti-reflection coating or an index matching material may also be provided, and the anti-reflection coating or the index matching material may be provided in the gap. This anti-reflection coating or the index matching material may be deposited against the end-face of an optical fiber. The force generated by the spring 1163 may be between 0.5 N and 2 N and the anti-reflection coating or the index matching material may contact the optical fiber and the one or more optical waveguides of the substrate. This may be beneficial to maintain desirable properties for the connection while reducing the amount of force generated by a spring 1163 against the substrate 1002. In some embodiments, the additional force generated by the spring 1163 is between 0.5 N and 2 N and the anti-reflection coating or the index matching material contacts the substrate 1002 and the ferrule 1120.

The connector 1160 may also comprise finger tab 1161. The finger tab 1161 may be configured to enable a user to grasp the connector to provide enough retraction force to cause the locking feature 1165 of the receiver portion 1167 to disengage from the capture feature 655 (FIG. 6C) of a guide pin 654 (FIG. 6C)—such as by the teeth 1069a, 1069b expanding around the guide pin head 1057 as the connector is pulled away from the guide pin 1054. This may allow the guide pin 654 (FIG. 6C) to be retracted from the receiver portion 1167 and the connector 1160. Thus, the locking feature 1165 of the receiver portion 1167 may be released from a capture state (e.g., the teeth 1069a, 1069b shown in FIG. 10D may expand away from each other) and enable relative movement of the at least one guide pin with respect to the locking feature 1165. In some embodiments, upon being released from the capture state, the spring 1163 will naturally urge the spring guide 1169 and the ferrule 1120 away from the receiver portion 1167.

In some embodiments, when the locking feature 1165 releases from the capture state, the spring 1163 is configured to push the locking feature 1165 away from the at least one guide pin. This may be done, for example, by controlling the diameter of a first section and a second section of a guide pin as discussed above in reference to FIG. 10A. Where guide pins 1054 comprise a first section 1059 and a second section 1052 as illustrated in FIG. 10A, the second section 1052 may be configured to be received within a hole in a ferrule 1120, and the first section 1059 may be configured so that it may not be received within a hole in a ferrule. This may be done, for example, by making the diameter ØE2 of the second section 1052 sufficiently small to allow the second section 1052 to be received within a ferrule hole and by making the diameter ØE1 of the first section 1059 larger than the diameter or size of the ferrule hole. Thus, when the spring 1163 urges the spring guide 1169 and the ferrule 1120 away from the receiver portion 1167, the ferrule 1120 may also contact the first section 1059 of the guide pins 1054, causing the guide pins 1054 to also retract.

Various approaches may be taken to assemble a system for aligning a substrate with an optical fiber. FIG. 12 is one example flow chart illustrating operations that may be performed to align a substrate with an optical fiber. At operation 1280, an optical fiber is provided. A connector is provided at operation 1284. The optical fiber may be received within the connector in operation 1286. At operation 1287, a substrate is provided, and the substrate may comprise a guide pin and optical waveguides. The substrate may be a substrate similar to those described above. At operation 1288, the connector may be removably or permanently connected to the substrate. Operations described herein may be performed in any order unless otherwise noted. Further, additional operations may be performed (such as separating the connector and substrate), and some operations may be omitted.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A system for aligning a substrate with an optical fiber, the system comprising:
the optical fiber;
the substrate comprising:
one or more optical waveguides;
at least one guide pin defining a first end and a second end, wherein the at least one guide pin comprises a capture feature proximate the second end; and
a substrate body comprising a receiving feature configured to receive and connect the first end of the at least one guide pin, wherein the second end for the at least one guide pin extends outwardly from the substrate body; and
a connector comprising:
at least one receiver portion defining a recess and comprising a locking feature, wherein the connector is configured to receive the optical fiber,
wherein the recess of the at least one receiver portion is configured to receive the at least one guide pin, and wherein the capture feature is configured to engage with the locking feature, wherein, when the capture feature is engaged with the locking feature, the optical fiber is aligned with the one or more optical waveguides and restrained from movement relative to the substrate.

2. The system of claim 1, wherein the capture feature of the at least one guide pin comprises a first portion proximate to the second end and a second portion proximate to the second end, the first portion having an increased thickness relative to the second portion, the first portion being closer to the second end than the second portion, and wherein at least one of the first portion or the second portion is configured to engage with the locking feature.

3. The system of claim 1, wherein the capture feature is a groove within the at least one guide pin.

4. The system of claim 1, wherein the at least one guide pin is connected to the receiving feature using adhesive.

5. The system of claim 1, wherein the connector further comprises a finger tab that is configured to enable a user to grip the connector and provide a retraction force to cause the locking feature to release from a capture state and enable relative movement of the at least one guide pin with respect to the locking feature.

6. The system of claim 5, wherein the connector further comprises a spring, wherein, when the locking feature releases from the capture state, the spring is configured to push the locking feature away from the at least one guide pin.

7. The system of claim 1, wherein the connector further comprises a ferrule and a spring, wherein the ferrule is positioned between the substrate and the spring, wherein the ferrule is configured to receive the optical fiber and the at least one guide pin, wherein, when the at least one guide pin is captured by the locking feature, the spring generates a force against the ferrule to urge the ferrule towards the substrate.

8. The system of claim 7, wherein the spring is configured to urge an end-face of the optical fiber received within the ferrule against the one or more optical waveguides in the substrate.

9. The system of claim 7, wherein the force generated by the spring is between 2 N and 20 N, wherein the spring is configured to bring the optical fiber into physical contact with the one or more optical waveguides of the substrate.

10. The system of claim 7, further comprising an anti-reflection coating or an index matching material, wherein the ferrule is configured to receive the optical fiber, wherein the optical fiber comprises an end-face, wherein the spring is configured to urge the ferrule proximate to the substrate while leaving a gap between the end-face of the optical fiber and the one or more optical waveguides of the substrate, wherein the anti-reflection coating or the index matching material is deposited against the end-face.

11. The system of claim 10, wherein the force generated by the spring is between 0.5 N and 2 N and wherein the anti-reflection coating or the index matching material contacts the optical fiber and the one or more optical waveguides of the substrate.

12. The system of claim 1, wherein the receiving feature is a trench, wherein the trench comprises two side edges and a bottom surface, wherein the trench is configured so that the at least one guide pin rests against the two side edges without contacting the bottom surface.

13. The system of claim 12, wherein the trench is formed using a laser based approach.

14. The system of claim 1, further comprising an attachment comprising the receiving feature, wherein the substrate is configured to receive and connect the attachment.

15. The system of claim 1, wherein the one or more optical waveguides are surface optical waveguides.

16. The system of claim 1, wherein the one or more optical waveguides are buried optical waveguides.

17. A connector for aligning a substrate having one or more optical waveguides with an optical fiber, the connector comprising:
at least one receiver portion defining a recess and comprising a locking feature,
wherein the connector is configured to receive the optical fiber, wherein the recess of the at least one receiver portion is configured to receive at least one guide pin associated with the substrate, wherein, when received, the locking feature is configured to retain the at least one guide pin in the recess, wherein, when the at least one guide pin is retained by the locking feature, the optical fiber is aligned with the one or more optical waveguides of the substrate and restrained from movement relative to the substrate.

18. The connector of claim 17, wherein the connector further comprises a finger tab that is configured to enable a user to grip the connector and provide a retraction force to cause the locking feature to release from a capture state and enable relative movement of the at least one guide pin with respect to the locking feature.

19. The connector of claim 18, wherein the connector further comprises a spring, wherein, when the locking feature releases from the capture state, the spring is configured to push the locking feature away from the at least one guide pin.

20. The connector of claim 17, further comprising a ferrule and a spring, wherein the ferrule is positioned between the substrate and the spring, wherein the ferrule is configured to receive the optical fiber and the at least one guide pin, wherein, when the at least one guide pin is captured by the locking feature, the spring generates a force against the ferrule to urge the ferrule towards the substrate.

21. A substrate for providing optical connections to at least one photonic integrated circuit, the substrate comprising:
one or more optical waveguides;
at least one guide pin defining a first end and a second end, wherein the at least one guide pin comprises a capture feature proximate the second end; and
a substrate body comprising a receiving feature configured to receive and connect the first end of the at least one guide pin,
wherein the second end for the at least one guide pin extends outwardly from the substrate body, wherein the capture feature is configured to engage with a connector, wherein, when the capture feature is engaged with the connector, an optical fiber associated with the connector is aligned with the one or more optical waveguides of the substrate and restrained from movement relative to the substrate.

22. The substrate of claim 21, wherein the capture feature of the at least one guide pin comprises a first portion proximate to the second end of the at least one guide pin and a second portion proximate to the second end of the at least one guide pin, the first portion having an increased thickness relative to the second portion, the first portion being closer to the second end than the second portion, and wherein one of the first portion or the second portion is configured to engage with the locking feature.
